(19) United States
(12) Patent Application Publication
(10) Pub. No.: US 2013/0328902 A1
(43) Pub. Date: Dec. 12, 2013

(54) GRAPHICAL USER INTERFACE ELEMENT INCORPORATING REAL-TIME ENVIRONMENT DATA

(71) Applicant: Scott A. Grant, Sunnyvale, CA (US)

(72) Inventor: Scott A. Grant, Sunnyvale, CA (US)

(73) Assignee: Apple Inc., Cupertino, CA (US)

(21) Appl. No.: 13/493,309

(22) Filed: Jun. 11, 2012

(51) Int. Cl. G09G 5/00; G06F 3/02; G09G 5/02

(52) U.S. Cl. 345/589; 345/207; 345/168

(57) ABSTRACT

A graphical user interface element incorporates real-time environment data from the user's environment. For example, a live video image captured by a local camera can be incorporated into the GUI, e.g., in a background region of a GUI element such as a menu bar. Front-facing (or rear-facing) camera images can be used to create a reflective (or translucent) effect. Color changes can reflect changes in ambient lighting. GUI elements can also be modified based on other real-time environment data, such as audio. The incorporation of real-time environment data into a user interface element for an application provides protection against spoofing of that element.

### BACKGROUND

The present disclosure relates in general to user interfaces and in particular to a graphical user interface element that incorporates real-time environment data.

A graphical user interface (GUI) for an application program typically includes various control buttons and/or text-entry areas. For example, in the case of a web browser, the GUI (sometimes referred to as the “chrome”) typically includes forward and back navigation buttons, a text-entry area where the user can type in an identifier (e.g., a uniform resource locator, or URL) for a web page to be retrieved, a search area where the user can type in a query to be submitted to a search engine, and so on.

Web browsers present content items (“pages”) supplied by various content creators. These pages may include interactive elements (links, forms, etc.) that allow the user to enter information, select options, or access additional content items. In some cases an unscrupulous page creator may place an element on a page that “spoofs” (i.e., looks to the user like) the browser chrome or another data-entry interface generated by the user's computer system. When the user interacts with the spoofed interface, the page creator is able to capture information, e.g., a URL, login credentials, or other data entered by the user. The captured information can be used for nefarious purposes, e.g., to direct the user to a spoofed website where the user is prompted to supply personal information.

### SUMMARY

Certain embodiments of the present invention provide a graphical user interface (“GUI”) element that incorporates real-time environment data from the user's environment. For example, if the user views the GUI on a device that includes a camera, a live video image captured by the camera can be incorporated into the GUI, e.g., in a background region of a GUI element such as a menu bar. In some embodiments, a rear-facing camera (looking in the same direction as the user viewing the display) can capture live video, and the user interface element can present a semi-transparent effect by incorporating information from the live video. In other embodiments, a front-facing camera (looking toward the user) captures live video, and the user interface element can present a semi-reflective effect incorporating information from the live video. Other embodiments can make use of live video to create other effects, e.g., dynamically changing the color of the interface element to reflect ambient lighting or changes in same. Still other embodiments can use other environmental data to modify the user interface. For example, a GUI element can be modified based on audio input, e.g., by changing a color of the element based on volume of sound, “pulsing” the element in time with the beat of ambient music, or the like.

The incorporation of real-time environment data into a user interface element for an application provides protection against spoofing of that element within a content item being displayed by that application, provided that the creator of the content item does not have access to the real-time environment data or the ability to modify the presentation of the content item in real time. The incorporation of real-time environment data in a manner that cannot be spoofed can help the user distinguish more confidently between a “genuine” GUI associated with an application or operating system function on the user's device and a “spoofed” GUI.

The following detailed description together with the accompanying drawings will provide a better understanding of the nature and advantages of the present invention.

### BRIEF DESCRIPTION OF THE DRAWINGS

FIG. 1 is a block diagram of a computer system according to an embodiment of the present invention.

FIG. 2 illustrates a browser screen that incorporates a real-time video image according to an embodiment of the present invention.

FIG. 3 illustrates a browser screen that incorporates a real-time video image from a rear-facing camera according to an embodiment of the present invention.

FIG. 4 illustrates a settings screen that can be presented to a user to allow the user to select preferences related to a real-time video image incorporated into a graphical user interface according to an embodiment of the present invention.

FIG. 5 is a flow diagram of a process that can be implemented according to an embodiment of the present invention

### DETAILED DESCRIPTION

Certain embodiments of the present invention provide a graphical user interface (“GUI”) element that incorporates real-time environment data from the user's environment. For example, if the user views the GUI on a device that includes a camera, a live video image captured by the camera can be incorporated into the GUI, e.g., in a background region of a GUI element such as a menu bar. In some embodiments, a rear-facing camera (looking in the same direction as the user viewing the display) can capture live video, and the user interface element can present a semi-transparent effect by incorporating information from the live video. In other embodiments, a front-facing camera (looking toward the user) captures live video, and the user interface element can present a semi-reflective effect incorporating information from the live video. Other embodiments can make use of live video to create other effects, e.g., dynamically changing the color of the interface element to reflect ambient lighting or changes in same. Still other embodiments can use other environmental data to modify the user interface. For example, a GUI element can be modified based on audio input, e.g., by changing a color of the element based on volume of sound, “pulsing” the element in time with the beat of ambient music, or the like.

The incorporation of real-time environment data into a user interface element for an application provides protection against spoofing of that element within a content item being displayed by that application, provided that the creator of the content item does not have access to the real-time environment data or the ability to modify the presentation of the content item in real time. The incorporation of real-time environment data in a manner that cannot be spoofed can help the user distinguish more confidently between a “genuine” GUI associated with an application or operating system function on the user's device and a “spoofed” GUI.

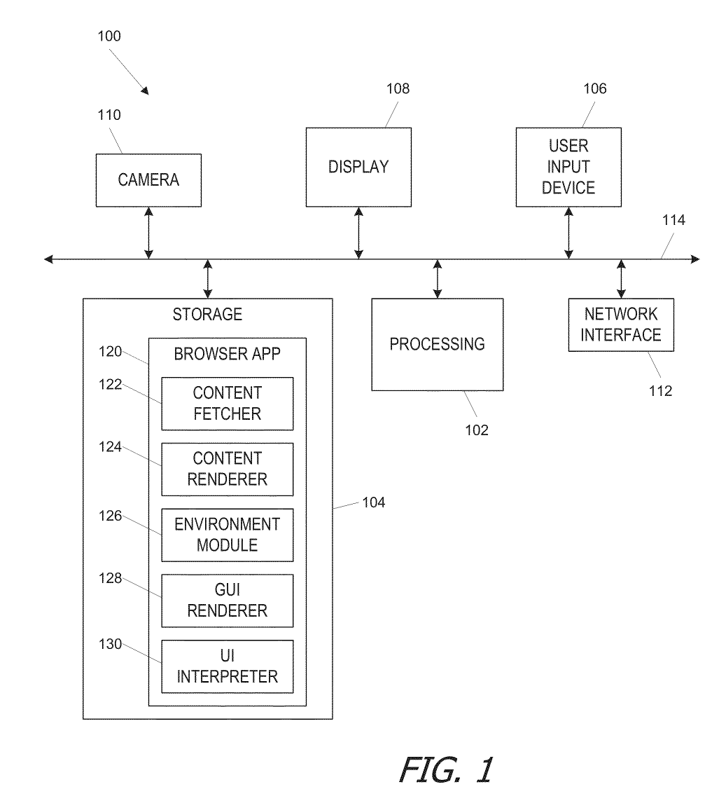

FIG. 1 is a block diagram of a computer system 100 according to an embodiment of the present invention. System 100 can be implemented in any type of user-operable computing device, including desktop computers, laptop computers, tablet computers, handheld devices (e.g., smart phones, media players), and so on. System 100 can include a number components such as processing subsystem 102, storage subsystem 104, user input device 106, display 108, camera 110 and network interface 112 communicating via bus 114.

Processing subsystem 102 can include a single processor, which can have one or more cores, or multiple processors. In some embodiments, processing subsystem 102 can include a general-purpose primary processor as well as one or more special-purpose co-processors such as graphics processors, digital signal processors, or the like. In some embodiments, some or all processors in processing subsystem can be implemented using customized circuits, such as application specific integrated circuits (ASICs) or field programmable gate arrays (FPGAs). In some embodiments, such integrated circuits execute instructions that are stored on the circuit itself. In other embodiments, processing subsystem 102 can execute instructions stored in storage subsystem 104.

Storage subsystem 104 can include various memory units such as a system memory, a read-only memory (ROM), and a permanent storage device. A ROM can store static data and instructions that are needed by processing subsystem 102 and other modules of computer system 100. The permanent storage device can be a read-and-write memory device. This permanent storage device can be a non-volatile memory unit that stores instructions and data even when computer system 100 is powered down. In some embodiments, a mass-storage device (such as a magnetic or optical disk or flash memory) can be used as a permanent storage device. Other embodiments can use a removable storage device (e.g., a floppy disk, a flash drive) as a permanent storage device. The system memory can be a read-and-write memory device or a volatile read-and-write memory, such as dynamic random access memory. The system memory can store some or all of the instructions and data that the processor needs at runtime.

Storage subsystem 104 can include any combination of computer readable storage media including semiconductor memory chips of various types (DRAM, SRAM, SDRAM, flash memory, programmable read-only memory) and so on. Magnetic and/or optical disks can also be used. In some embodiments, storage subsystem 104 can include removable storage media that can be readable and/or writeable; examples of such media include compact disc (CD), read-only digital versatile disc (e.g., DVD-ROM, dual-layer DVD-ROM), read-only and recordable Blu-ray® disks, ultra density optical disks, flash memory cards (e.g., SD cards, mini-SD cards, micro-SD cards, etc.), magnetic “floppy” disks, and so on. The computer readable storage media do not include carrier waves and transitory electronic signals passing wirelessly or over wired connections.

In some embodiments, storage subsystem 104 can store one or more software programs to be executed by processing subsystem 102, such as a browser application 120. “Software” refers generally to sequences of instructions that, when executed by processing subsystem 102 cause computer system 100 to perform various operations, thus defining one or more specific machine implementations that execute and perform the operations of the software programs. The instructions can be stored as firmware residing in read-only memory and/or applications stored in magnetic storage that can be read into memory for processing by a processor. Software can be implemented as a single program or a collection of separate programs or program modules that interact as desired. Programs and/or data can be stored in non-volatile storage and copied in whole or in part to volatile working memory during program execution. From storage subsystem 104, processing subsystem 102 can retrieve program instructions to execute and data to process in order to execute various operations including operations described below.

A user interface can be provided by one or more user input devices 106, display device 108, and/or and one or more other user output devices (not shown). Input devices 106 can include any device via which a user can provide signals to computing system 100; computing system 100 can interpret the signals as indicative of particular user requests or information. In various embodiments, input devices 106 can include any or all of a keyboard touch pad, touch screen (e.g., a touch-sensitive overlay on a display surface of display 108), mouse or other pointing device, scroll wheel, click wheel, dial, button, switch, keypad, microphone, and so on.

Display 108 can display images generated by computing system 100 and can include various image generation technologies, e.g., a cathode ray tube (CRT), liquid crystal display (LCD), light-emitting diode (LED) including organic light-emitting diodes (OLED), projection system, or the like, together with supporting electronics (e.g., digital-to-analog or analog-to-digital converters, signal processors, or the like). Some embodiments can include a device such as a touchscreen that function as both input and output device. In some embodiments, other user output devices can be provided in addition to or instead of display 108. Examples include indicator lights, speakers, tactile “display” devices, printers, and so on.

In some embodiments, the user interface can provide a graphical user interface, in which visible image elements in certain areas of display 108 are defined as active elements or control elements that the user selects using user input devices 106. For example, the user can manipulate a user input device to position an on-screen cursor or pointer over the control element, then click a button to indicate the selection. Alternatively, the user can touch the control element (e.g., with a finger or stylus) on a touchscreen device. In some embodiments, the user can speak one or more words associated with the control element (the word can be, e.g., a label on the element or a function associated with the element). In some embodiments, user gestures on a touch-sensitive device can be recognized and interpreted as input commands; these gestures can be but need not be associated with any particular area on display 108. Other user interfaces can also be implemented.

Camera 110 can collect images of the environment surrounding computer system 100. In some embodiments, computer system 100 (or a portion thereof, such as display 108) is encased in a housing, and camera 110 can be built in the housing with its optical system exposed and pointed in some particular direction. For example, a “front-facing” camera can be mounted on display 108 and oriented to capture images of someone looking at images on display 108. A “rear-facing” camera can be mounted on the back of display 108 and oriented to capture images of the environment in front of someone looking at images on display 108. In some embodiments, camera 110 is not fixedly mounted on a housing of computer system 100 (or any portion thereof). For example, camera 110 may be rotatably mounted, e.g., on top of the display. As another example, camera 100 can be implemented using a camera accessory that is detachably connected to the rest of computer system 100 using an external port and a cable or a wireless connection.

Network interface 112 can provide voice and/or data communication capability for computer system 100. In some embodiments, network interface 112 can include radio frequency (RF) transceiver components for accessing wireless voice and/or data networks (e.g., using cellular telephone technology, advanced data network technology such as 3G, 4G or EDGE, WiFi (IEEE 802.11 family standards), or other mobile communication technologies, or any combination thereof, GPS receiver components, and/or other components. In some embodiments, network interface 112 can provide wired network connectivity (e.g., Ethernet) in addition to or instead of a wireless interface. Network interface 112 can be implemented using a combination of hardware (e.g., antennas, modulators/demodulators, encoders/decoders, and other analog and/or digital signal processing circuits) and software components.

Bus 114 can include various system, peripheral, and chipset buses that communicatively connect the numerous components of computer system 100. For example, bus 114 can communicatively couple processing subsystem 102 with storage subsystem 104. Bus 114 can also connect to input devices 106 and display 108. Bus 114 can also couple processing subsystem 102 to a network through network interface 112. In this manner, computing system 100 can be connected to a network of multiple computer systems (e.g., a local area network (LAN), a wide area network (WAN), an Intranet, or a network of networks, such as the Internet. Any or all components of computer system 100 can be used in conjunction with the invention.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter.

Through suitable programming, processing subsystem 102 can provide various functionality for computing system 100. For example, processing subsystem 102 can execute browser application 120. Browser application 120 can provide various functionality such as the ability to retrieve and display content items from local or remote sources (e.g., using HTTP or other data transfer protocols to retrieve and display web pages) and the ability to receive and interpret user input pertaining to the content items, such as selection of an item to view, submission of data by the user in response to a particular content item (e.g., filling out a form on an interactive web page), and so on.

In some embodiments, browser application 120 can incorporate various interoperating modules (e.g., blocks of code) that, when executed, implement aspects of browser operation. For example, browser 120 can include a content fetcher 122, a content renderer 124, an environment module 126, a GUI renderer 128, and a UI interpreter 130.

Content fetcher 122 can include instructions for interpreting URLs (uniform resource locators) or other identifiers of content items to be retrieved and displayed, as well as instructions for interacting with network interface 112 to fetch the content items. Content renderer 124 can include instructions for interpreting fetched content items and rendering displayable images (including still and/or video images). In some instances, the content items may include audio, and content renderer 124 can render audio as well as images. Content fetcher 122 and content renderer 124 can incorporate conventional techniques for fetching and rendering content items (e.g., HTML interpreters, audio and/or video streaming programs, etc.).

Environment module 126 can collect real-time data from the physical environment of computing system 100 to be incorporated into the user interface of browser application 120. For example, in some embodiments, environment module 126 includes instructions to control operation of camera 110 to obtain video images of the environment. Environment module 126 can also process the collected data, e.g., applying filters to blur or unsharpen received images.

GUI renderer 128 can create graphical user interface (GUI) elements to be presented to the user along with the content items rendered by content renderer 124. GUI renderer 128 can include code defining the location and appearance of GUI elements, such as navigation buttons (forward, back), a URL entry window, a search box, and the like. In accordance with some embodiments of the invention, GUI renderer 128 can incorporate real-time environment data provided by environment module 126 into some or all of the GUI elements. Examples are shown below.

UI interpreter 130 can receive user input, e.g., via user input device 106, and can interpret the input to determine actions to be performed by browser application 120. For example, UI interpreter 130 can determine which GUI element the user selected and initiate the corresponding action (e.g., fetching a content item based on a URL entered by the user). In some embodiments, UI interpreter 130 can incorporate conventional techniques for interpreting user input.

It will be appreciated that computer system 100 is illustrative and that variations and modifications are possible. Computer system 100 can have other capabilities not specifically described here (e.g., mobile phone, global positioning system (GPS), power management, various connection ports for connecting external devices or accessories, etc.). Further, while computer system 100 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Browser application 120 is also illustrative, and specific implementations may include more or fewer modules than described herein. Certain aspects of browser application 120 can be implemented using conventional techniques.

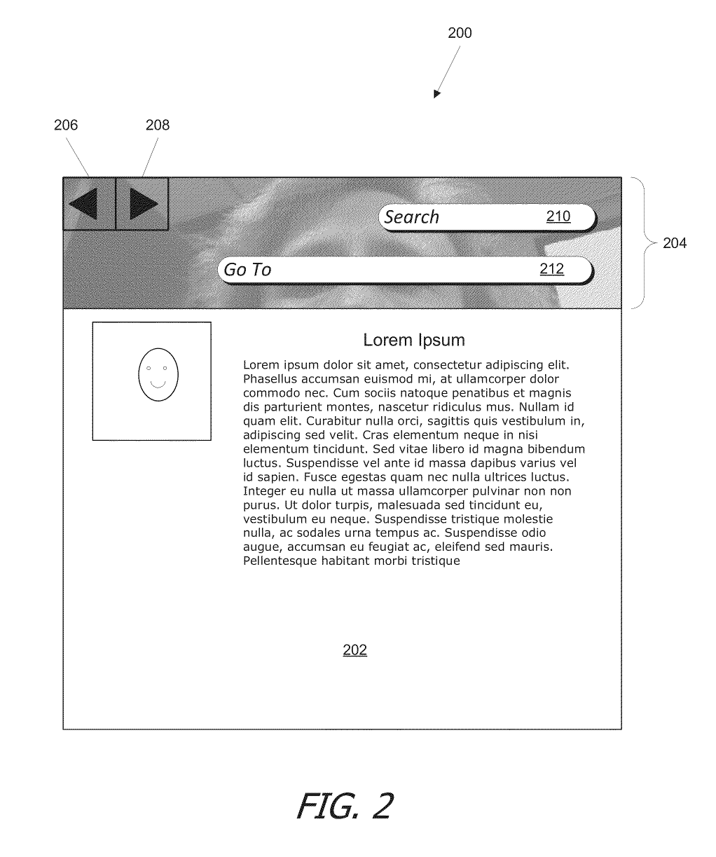

In some embodiments, browser 120 incorporates real-time environmental information into one or more GUI elements. FIG. 2 illustrates a browser screen 200 that incorporates a real-time video image according to an embodiment of the present invention. Browser screen 200 can be rendered, e.g., on display 108 of computer system 100. Depending on the particular implementation of system 100, screen 200 may fill the entire display area, or it may be rendered (e.g., in a window) in a portion of the display area.

Browser screen 200 includes a content display area 202 in which content items (e.g., web pages) can be rendered. In some embodiments, rendering of content is controlled by content renderer 124 based on content fetched by content fetcher 122.

Browser screen 200 also includes a GUI area 204 (also referred to as the “chrome”) where various user-operable control elements are arranged. For example, the control elements can include back and forward navigation buttons 206, 208, search bar 210, and URL (“Go To”) bar 212. A user can navigate between recently viewed pages using buttons 206, 208. A user can execute a search using a selected search engine by entering a query into search bar 210. A user can also find a web page by entering the URL (or a portion thereof) into URL bar 212. It is to be understood that other control elements can be added or substituted for those shown; the particular combination or arrangement of control elements is not critical to understanding the present invention.

The background of chrome 204 incorporates real-time environment data, e.g., as provided by environment module 126. In this example, a front-facing camera is used to obtain a video image that includes part of the user's face and an area around the user. The video image can be blended with a “default” background color (e.g., solid gray or a smoothly varying color), to reduce contrast and/or improve visibility of the GUI elements. The image can be mirrored (i.e., left and right reversed) to create the illusion that browser chrome 204 is reflective.

In some embodiments, the image is updated in real-time. For example, environment module 126 can operate camera 110 to collect real-time video images; as used herein, collecting real-time video images can include any operation that collects images at a rate of about 10 frames per second or higher (e.g., up to 30 frames per second for standard video cameras). Environment module 126 can supply the video images, with minimal or no delay, to GUI renderer 128, and GUI renderer 128 can repeatedly re-render the GUI to incorporate the real-time video images as they are received. In some embodiments, GUI renderer 128 may re-render the GUI at a rate different from the frame rate used by camera 110.

Regardless of particular details of frame rate and/or re-rendering rate, if the user moves (or if the camera that is capturing the video moves), chrome 204 will change accordingly, and the change will be visible to the user in real time. Thus, in some embodiments, a user can “test” whether chrome 204 is genuine by executing detectable movement; for example, the user can wave a hand in front of the camera, shift her position, or shift the camera's position.

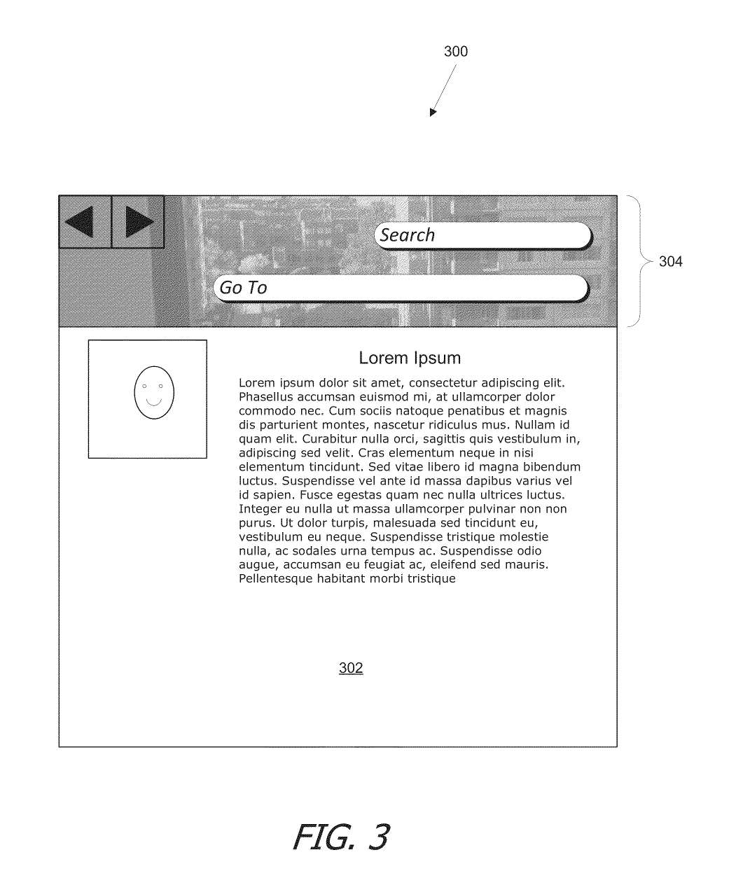

In another embodiment, a rear-facing camera can be used to provide a “transparent” chrome. FIG. 3 illustrates a browser screen 300 that incorporates a real-time video image from a rear-facing camera according to an embodiment of the present invention. Like browser screen 200, browser screen 300 can be rendered, e.g., on display 108 of computer system 100.

Browser screen 300 includes a content display area 302 in which content items (e.g., web pages) can be rendered, as described above, and a GUI area, or chrome, 304 where various user-operable control elements are arranged. These elements can be the same as the control elements described above with reference to FIG. 2.

The background of chrome 304 incorporates real-time environment data, e.g., as provided by environment module 126. In this example, a rear-facing camera is used to obtain a video image that includes an area presumed to be in the field of view of the user (on the assumption that the user is looking at the front surface of the display). As with chrome 304 the image can be blended with a background color to reduce contrast within the image and/or improve visibility of the GUI elements. This can create the illusion of looking through the display, as if portions of the display device were wholly or partially transparent.

As with chrome 204, in some embodiments, the background of chrome 304 can be updated in real-time, e.g., by operating camera 110 to capture video images and redrawing chrome 304 at a suitable frame rate. If the camera that is capturing the video moves, or if someone walks in front of the camera, or if some other change in the environment occurs, that change can be visible to the user in real time as a change in chrome 304.

The incorporation of real-time video images into a user interface element, e.g., as shown in FIGS. 2 and 3, provides assurance that the interface element is genuine (i.e., part of an application or operating-system program on the user's device) and is not a spoof created by a content item being viewed. As long as the content provided to content renderer 124 does not have the capability to incorporate real-time video data, chrome 204 or chrome 304 cannot be accurately spoofed by a content item being displayed. Thus, the real-time updating of chrome 204 or chrome 304 can help the user distinguish the genuine browser chrome from a spoof provided by a third party. If in doubt, the user can check, e.g., by moving the camera (which may entail moving the entire device if the camera is built into the device) or moving an object in the field of view of the camera (e.g., waving a hand).

It will be appreciated that the user interfaces described herein are illustrative and that variations and modifications are possible. For example, the video image can be softened or diffused; like blending with a smooth background color, this can help reduce contrast within the background image and improve visibility of foreground GUI elements. In some embodiments, the real-time video image can be confined to a portion of the GUI area. For example, referring to FIG. 2, the image can be visible behind search bar 210 or URL bar 212, but not visible behind forward and backward navigation buttons 206, 208.

In some embodiments, the real-time video image can extend into text entry areas (e.g., search bar 210 and/or URL bar 212 of FIG. 2); the image can be mostly opaque in these areas to facilitate the user's ability to read text. Foreground colors of GUI elements may be changed depending on the image color to enhance their visibility (e.g., by selecting colors based on contrast-optimization algorithms, examples of which are known in the art).

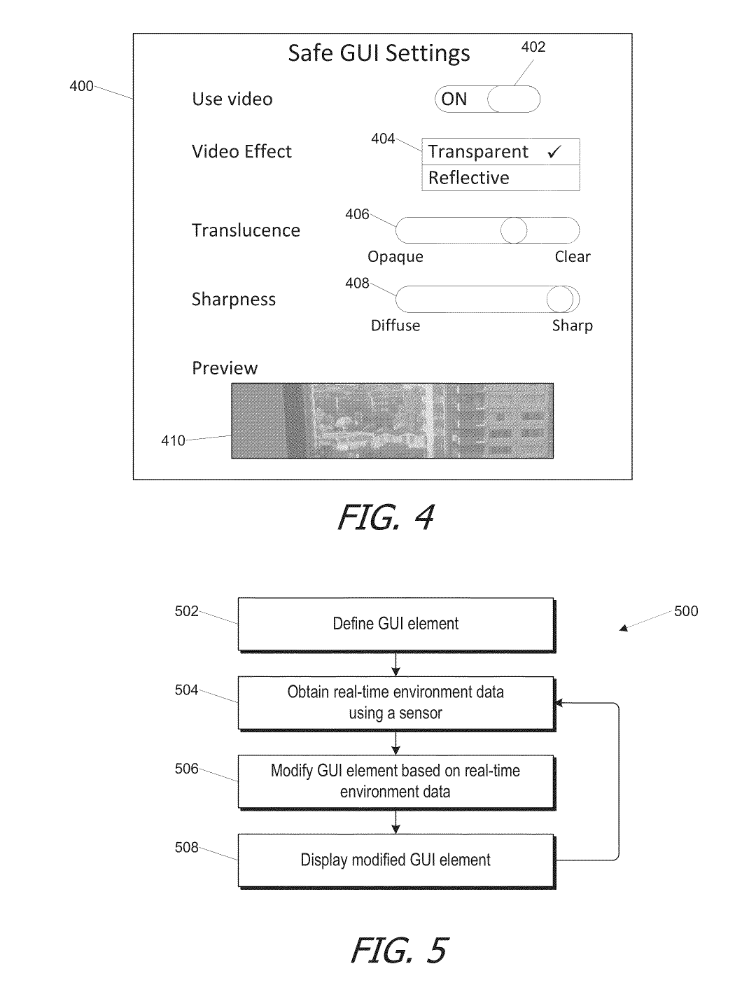

In some embodiments, the real-time image can be adjusted to suit user preferences. FIG. 4 illustrates a settings screen 400 that can be presented to a user to allow the user to select preferences related to a real-time video image incorporated into a GUI according to an embodiment of the present invention. Screen 400 can be accessible, e.g., through a “settings” menu associated with browser application 120 of FIG. 1 or through a “settings” menu associated with an operating system for computer system 100.

Switch 402 allows the user to select whether to incorporate real-time video into the GUI or not. In some embodiments, a user may choose not to incorporate video, e.g., to reduce power consumption. Menu 404 allows the user to select between a transparent effect (e.g., screen 300 of FIG. 3) or a reflective effect (e.g., screen 200 of FIG. 2). Selection options can be varied based on the availability of various cameras. For instance, if the device has only a front-facing camera, a “transparent” option would not be presented. If the device has a camera whose orientation is not tied to or controlled by the device (e.g., a freestanding camera accessory), an option to use that camera may be presented without specifying the particular effect to be achieved.

Translucence slider 406 and sharpness slider 408 are examples of control elements allowing the user to adjust esthetic qualities of the image. For example, translucence slider 406 can control a blending fraction used to blend the image data with a solid background color (e.g., the color that would be used if “use video” is turned off with switch 402). The user can select within a range from “opaque” (dominated by the solid background color) to “clear” (no contribution from the solid-background color). Sharpness slider 408 can control the extent to which the image is blurred to reduce sharp edges, in a range from “diffuse” (very blurred) to “sharp” (not blurred). For example, a kernel-based filter can be applied to the image to blend adjacent pixels, and adjusting slider 408 can adjust the kernel to encompass a larger number of pixels and/or adjust the relative weights of different pixels.

Preview pane 410 can allow the user to see, in real time, the effect of the settings selected with menu 404 and sliders 406, 408. Preview pane 410 can be rendered by operating the relevant camera (e.g., rear-facing if “transparent” is selected in menu 404, front-facing if “reflective” is selected) and rendering an image using the live video as modified based on the current translucence and sharpness selections. In some embodiments, if “use video” is disabled, preview pane 410 can show the solid background color. With “use video” enabled, the user can adjust the settings to obtain a desired look. For some users, a less-sharp and/or less-translucent image may provide more comfortable viewing of GUI elements; other users may prefer a more strongly transparent or reflective effect.

As noted above, a GUI incorporating real-time environment data can be provided, e.g., by GUI renderer 128 with input from environment module 126. FIG. 5 is a flow diagram of a process 500 that can be implemented according to an embodiment of the present invention.

At block 502, a GUI element can be defined. In some embodiments, a GUI element can include a selectable virtual button, a text entry box, a slider, a menu, or other object that is to be drawn in a particular area of a display (or a window associated with the application controlled by the GUI). In some embodiments, defining the GUI element can include defining a default background color (or colors) for the element and a default foreground color (or colors) for the element.

At block 504, real-time environment data can be obtained using a sensor. For example, as described above, environment module 126 can control operation of camera 110 to obtain real-time video images.

At block 506, the GUI element can be modified based on the real-time environment data. For example, background colors can be modified by blending the default background color with pixel colors from the real-time video images as described above. The blending can be controlled based on preset or user-adjustable parameters (e.g., the translucence and sharpness parameters in FIG. 4). In some embodiments, foreground colors for the GUI element can also be modified. For example, a foreground color can be modified based on the modified background colors, e.g., to enhance contrast between the foreground and background. In other embodiments, modifying the GUI element can include modifying a foreground color based on the real-time environment data in addition to or instead of modifying a background color.

At block 508, the modified GUI element is displayed. Thereafter process 500 can return to block 504 to obtain updated real-time data and update the displayed GUI element accordingly. Thus, the GUI can be continually updated based on the real-time environment data.

It will be appreciated that process 500 is illustrative and that variations and modifications are possible. Steps described as sequential may be executed in parallel, order of steps may be varied, and steps may be modified, combined, added or omitted.

In some embodiments, the GUI can incorporate different levels of image detail. For example, the background area of the GUI can be rendered in an average color based on the real-time image data. In some embodiments, a global average of the pixel colors of the image is computed and used to determine the background color. In other embodiments, a local weighted average is taken over each of a number of sections and used to color pixels in that section; pixels near the edges of sections can be blended for a smoother transition. In these embodiments, it is still possible for a user to verify that the GUI is locally generated. For example, the user can move the camera or hold an object in front of the camera to change the average color; such a change would be reflected in the GUI as long as the GUI is being updated in real time as described above.

In some embodiments, the real-time environment data need not include images. For example, where the computer system includes a microphone able to pick up ambient sound, audio data can be used, with colors being mapped to the volume of sound and/or frequency distribution of the sound sampled over some period of time. The user can see the GUI changing in time with ambient sounds, and the user can test whether the GUI is locally generated, e.g., by making a sound and observing a real-time color change. More generally, any real-time environment data that is perceptible to the user and detectable by a sensor of the computer system that renders the GUI can be used. Where the user can intentionally alter the real-time environment and observe that the GUI is correspondingly modified in real time, the user's confidence that the GUI is legitimate can be enhanced.

In some embodiments, the GUI may include a control element allowing the user to select whether real-time environment data is incorporated. The user can, for example, enable the incorporation of real-time environment data long enough to verify that the GUI is genuine, then disable the incorporation to facilitate interaction with the GUI or to minimize distraction while interacting with other displayed information (for example, if the user is watching a video, changes in the GUI may be distracting). When incorporation of real-time environment data is disabled, the GUI can be rendered with a default color scheme.

While the invention has been described with respect to specific embodiments, one skilled in the art will recognize that numerous modifications are possible. For example, while embodiments described above make reference to web pages as the content items, other types of content items can also be the subject of browsing. Examples include document files (which may be stored locally on the user's computer or remotely), photos, media items, content streams (e.g., different TV channels and/or video-streaming channels and/or audio-streaming channels.

A browser can include any computer program or other tool that allows a user to view and interact with content items. While browsers can be implemented as software executing on appropriate hardware, other implementations are possible, and a browser can be adapted for specific types of content items (e.g., web browser, document browser, etc.).

Further, although embodiments described above make reference to a browser, the present invention is not limited to browsers. Real-time environment information can be incorporated into any graphical user interface element that is rendered locally to the user (so that the information corresponds to the user's perception of the environment), and this can help the user confirm that the elements are being rendered locally and not being “spoofed” by some remote source. Examples of GUI elements that can incorporate real-time data include login screens, prompts to update software, alert messages suggesting the user take some action, and so on.

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A method for providing a graphical user interface in an electronic device, the method comprising:
defining, by the electronic device, a first interface element for the graphical user interface;
obtaining, by the electronic device, real-time environment data using an environmental sensor of the electronic device;
modifying, by the electronic device, the first interface element based on the real-time environment data; and
displaying, by the electronic device, a graphical user interface that includes the modified first interface element.

2. The method of claim 1 wherein the first interface element includes a text entry area.

3. The method of claim 1 wherein the first interface element includes a background region surrounding a text entry area.

4. The method of claim 1 wherein the first interface element includes a user-selectable button element.

5. The method of claim 1 wherein the environmental sensor includes a camera and the real-time environment data includes images captured by the camera operating in a video mode.

6. The method of claim 1 wherein the camera is a front-facing camera and wherein modifying the first interface element includes blending a default color with the images captured by the camera to produce a semi-reflective effect.

7. The method of claim 1 wherein the camera is a rear-facing camera and wherein modifying the first interface element includes blending a default color with the images captured by the camera to produce a semi-transparent effect.

8. An electronic device comprising:
a display;
an environmental sensor; and
a processing subsystem coupled to the display and the environmental sensor, the processing subsystem configured to:
obtain real-time environment data from the environmental sensor; and
modify an element of a graphical user interface presented on the display based on the real-time environment data.

9. The device of claim 8 wherein the environmental sensor includes a camera and the processing subsystem is further configured to obtain the real-time environment data by operating the camera to capture a plurality of images per second.

10. The device of claim 8 wherein the processing subsystem is further configured to modify the element of the graphical user interface by incorporating at least a portion of each image

11. The device of claim 8 wherein the environmental sensor includes a microphone and the processing subsystem is further configured to:
obtain the real-time environment data by operating the microphone to obtain an audio signal; and
modify the element of the graphical user interface by changing a color of the element based on a property of the audio signal.

12. The device of claim 8 further comprising a network interface coupled to the processing subsystem, wherein the processing subsystem is further configured to obtain a content item via the network interface and to present the content item together with the graphical user interface on the display device.

13. An electronic device comprising:
a display;
a camera; and
a processing subsystem coupled to the display and the camera, the processing subsystem configured to execute:
a content fetcher to fetch a content item from a source;
a content renderer to render the content item on the display device;
an environment module to operate the camera to collect real-time video images; and
a graphical user interface renderer to render a graphical user interface on the display device, wherein the graphical user interface renderer incorporates at least a portion of the real-time video images collected by the environment module into the graphical user interface.

14. The electronic device of claim 13 further comprising a housing, wherein the camera and the display are visible through the housing.

15. The electronic device of claim 14 wherein the camera is a front-facing camera and the graphical user interface presents a reflective effect.

16. The electronic device of claim 14 wherein the camera is a rear-facing camera and the graphical user interface presents a translucent effect.

17. A method for generating a graphical user interface, the method comprising:
defining, by an electronic device, a first interface element for the graphical user interface;
obtaining, by the electronic device, real-time video images using a camera local to the electronic device;
rendering, by the electronic device, the first interface element for display, wherein rendering the first interface element includes incorporating data from the real-time video images into the first interface element; and
displaying, by the electronic device a graphical user interface that includes the rendered first interface element.

18. The method of claim 17 wherein incorporating the data from the real-time images includes blending pixels of the real-time video images with a default background color associated with the first interface element.

19. The method of claim 17 wherein incorporating the data from the real-time images includes filtering pixels of the real-time video images to produce a diffuse effect.

20. A computer-readable storage medium having program code stored thereon, the program code including instructions that, when executed by a processing subsystem of an electronic device, cause the processing subsystem to perform a method, the method comprising:
defining a first interface element for the graphical user interface;
obtaining real-time environment data using an environmental sensor of the electronic device;
modifying the first interface element based on the real-time environment data; and
displaying a graphical user interface that includes the modified first interface element.

21. The computer-readable storage medium of claim 20 wherein obtaining the real-time environment data includes obtaining real-time video images using a camera of the electronic device.

22. The computer-readable storage medium of claim 21 wherein incorporating the data from the real-time images includes blending pixels of the real-time video images with a default background color associated with the first interface element.

23. The computer-readable storage medium of claim 20 wherein obtaining the real-time environment data includes obtaining a real-time audio signal using a microphone of the electronic device.

24. The computer-readable storage medium of claim 21 wherein incorporating the data from the real-time images includes modifying a color of the first interface element based on a property of the real-time audio signal.
